(19) United States
(12) Patent Application Publication
(10) Pub. No.: US 2011/0007085 A1
(43) Pub. Date: Jan. 13, 2011

(54) MEMORY CALIBRATION METHOD AND DISPLAY APPARATUS APPLYING THE SAME

(75) Inventor: Yong-jae Kweon, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/779,626

(22) Filed: May 13, 2010

(30) Foreign Application Priority Data
Jul. 9, 2009 (KR) 10-2009-0062636

(51) Int. Cl. G09G 5/36

(52) U.S. Cl. 345/559

(57) ABSTRACT

A memory calibration method and a display apparatus using the memory calibration method are provided. The memory calibration method includes displaying an automatic calibration item, determining whether an automatic calibration command is input through the automatic calibration item, and automatically setting register setting values of the memory if it is determined that the automatic calibration command is input.

### CROSS-REFERENCE TO RELATED APPLICATION

This application claims priority from Korean Patent Application No. 10-2009-0062636, filed on Jul. 9, 2009 in the Korean Intellectual Property Office, the disclosure of which is incorporated herein by reference in its entirety.

### BACKGROUND

1. Field

Apparatuses and methods consistent with the exemplary embodiments relate to a memory calibration method and a display apparatus applying the same, and more particularly, to a memory calibration method for calibrating register setting values of a memory, and to a display apparatus applying the memory calibration method.

2. Description of the Related Art

Display apparatuses such as televisions (TVs) include high speed digital interfaces between main chips and memories in order to operate systems and perform video processing and audio processing. Additionally, calibration is performed according to the temperature and the type of application in order to optimize operations of memories.

In general, calibration of display apparatuses is performed during the manufacturing of products in factories. Accordingly, display apparatuses are fabricated with preset register setting values.

However, environments in which display apparatuses are actually used may differ from factory environments, so if calibration is performed during manufacturing of display apparatuses, it is difficult to perform calibration suitable for environments in which users use such display apparatuses. Therefore, there is a need for methods to perform calibration compatible with user environments.

### SUMMARY OF THE INVENTION

Exemplary embodiments address the above disadvantages and other disadvantages not described above. Also, the exemplary embodiments are not required to overcome the disadvantages described above, and an exemplary embodiment may not overcome any of the problems described above.

The exemplary embodiments provide a memory calibration method, in which an automatic calibration item is displayed on a screen of a display apparatus, and the register setting values of a memory are automatically set if it is determined that an automatic calibration command is input through manipulation of the automatic calibration item, and a display apparatus applying the memory calibration method.

According to an aspect of an exemplary embodiment, there is provided a memory calibration method of a display apparatus including a memory, the memory calibration method including displaying an automatic calibration item on a screen of the display apparatus, determining whether an automatic calibration command is input through manipulation of the automatic calibration item, and automatically setting the register setting values of the memory if it is determined that the automatic calibration command is input.

The register setting values of the memory may include a timing shift value of a data strobe (DQS) signal. The automatically setting may include computing a margin of the DQS signal, and setting the timing shift value of the DQS signal based on the computed margin.

The computing may include reading and recording data while shifting the DQS signal in sequence, and computing a shift range of the DQS signal in which the data is read and recorded normally, as the margin.

The setting may include setting a median value of the margin as the timing shift value of the DQS signal.

The memory may include a data sampling scheme memory employing a data sampling scheme in a double data rate mode.

The displaying may include displaying the automatic calibration item on an on-screen-display menu.

The memory calibration method may further include displaying on a screen information on whether an automatic calibration performed normally.

According to another aspect of an exemplary embodiment, there is provided a display apparatus including a memory, a display unit which displays an input video, and a controller which uses the memory as a volatile storage space, controls the display unit to display an automatic calibration item, determines whether an automatic calibration command is input through manipulation of the automatic calibration item, and automatically sets the register setting values of the memory if it is determined that the automatic calibration command is input.

The register setting values of the memory may include a timing shift value of a data strobe (DQS) signal. The controller may compute a margin of the DQS signal, and may set the timing shift value of the DQS signal using the computed margin.

The controller may read and record data while shifting the DQS signal in sequence, and may compute a shift range of the DQS signal in which the data is read and recorded normally, as the margin.

The controller may set a median value of the margin as the timing shift value of the DQS signal.

The memory may include a data sampling scheme memory employing a data sampling scheme in a DDR mode.

The controller may control the automatic calibration item to be displayed on an OSD menu.

The controller may control information on whether an automatic calibration performed normally to be displayed on a screen.

### BRIEF DESCRIPTION OF THE DRAWINGS

The above and/or other aspects will be more apparent by describing certain exemplary embodiments with reference to the accompanying drawings, in which:

FIG. 1 is a block diagram of a display apparatus according to an exemplary embodiment;

FIG. 2 is a flowchart explaining a memory calibration method according to an exemplary embodiment;

FIG. 3 is a view illustrating the type of signals which are transceived between a DDR memory and a controller according to an exemplary embodiment;

FIG. 4 is a view exemplarily illustrating a data strobe (DQS) signal and data (DQ) signal according to an exemplary embodiment;

FIG. 5 is a view illustrating a screen showing an OSD menu containing an automatic calibration item according to an exemplary embodiment;

FIG. 6 is a view illustrating a message displayed when setting of automatic calibration has completed normally according to an exemplary embodiment;

FIG. 7 is a view illustrating a message displayed when setting of automatic calibration has not completed normally according to an exemplary embodiment; and

FIG. 8 is a flowchart explaining a process of performing calibration if an error occurs in a DDR memory according to an exemplary embodiment.

### DETAILED DESCRIPTION OF EXEMPLARY EMBODIMENTS

Certain exemplary embodiments will now be described in greater detail with reference to the accompanying drawings.

In the following description, the same drawing reference numerals are used for the same elements even in different drawings. The matters defined in the description, such as detailed construction and elements, are provided to assist in a comprehensive understanding of the invention. Thus, it is apparent that the exemplary embodiments can be carried out without those specifically defined matters. Also, well-known functions or constructions are not described in detail since they would obscure the invention with unnecessary detail.

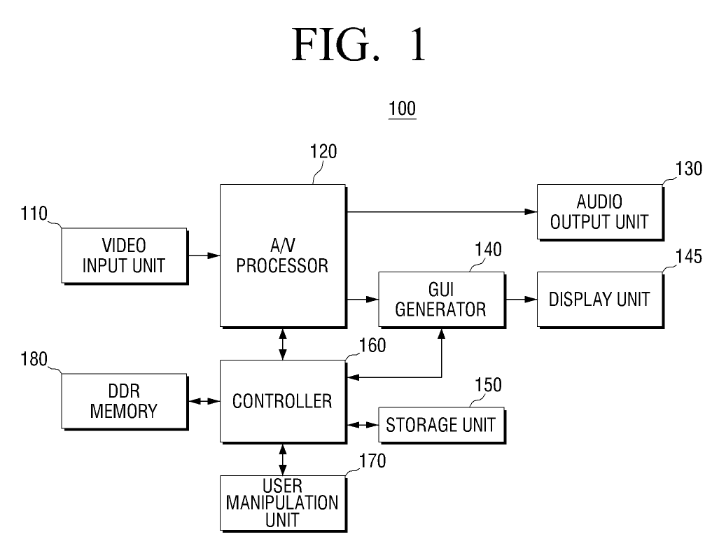

FIG. 1 is a block diagram of a display apparatus 100 according to an exemplary embodiment. In FIG. 1, the display apparatus 100 includes a video input unit 110, an audio/video (A/V) processor 120, an audio output unit 130, a GUI generator 140, a display unit 145, a storage unit 150, a controller 160, a user manipulation unit 170 and a DDR memory 180.

The video input unit 110 receives input of various video data. For example, the video input unit 110 may be one of a High Definition Multimedia Interface (HDMI), a component interface, a composite interface, an S-video interface and a digital visual interface (DVI). Additionally, the video input unit 110 may include a tuner which receives video using a broadcast signal. The video input unit 110 may receive video through a recording medium, such as a compact disc (CD), a digital versatile disk (DVD), or a Blu-ray.

The A/V processor 120 performs signal processing, such as video decoding, video scaling and audio decoding, with respect to a video signal and audio signal output from the video input unit 110. Additionally, the A/V processor 120 transmits the processed video signal and the processed audio signal to the GUI generator 140 and the audio output unit 130, respectively. Alternatively, if the video and audio signals are stored in the storage unit 150, the A/V processor 120 outputs the video and audio signal in compressed format to the storage unit 150.

The audio output unit 130 may output audio transmitted from the A/V processor 120 through a speaker, or by using an audio output terminal connected to an external speaker.

The GUI generator 140 generates a GUI to be provided to a user. The generated GUI may be displayed on a screen in the form of an OSD menu. In more detail, the GUI generator 140 generates an automatic calibration item through which a command to automatically set register setting values of the DDR memory 180 is input. Additionally, the GUI generator 140 generates an OSD menu containing an automatic calibration item and adds the generated OSD menu to a video.

The display unit 145 displays a video output from the A/V processor 120. Additionally, the display unit 145 displays a video on which the GUI generated by the GUI generator 140 is superimposed in the form of an OSD menu. In other words, the display unit 145 displays the OSD menu containing the automatic calibration item on the screen.

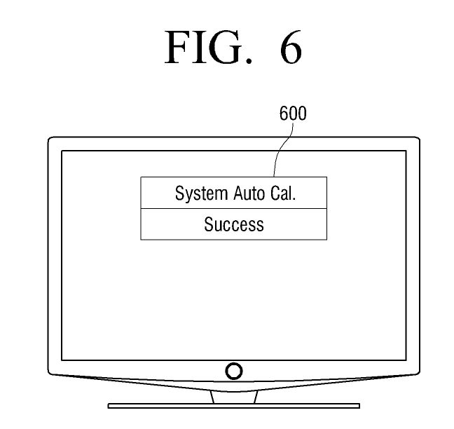

The display unit 145 also displays on the screen information on whether automatic calibration has performed normally. For example, if the automatic calibration has performed normally, the display unit 145 may display on the screen a calibration success message, as shown in FIG. 6.

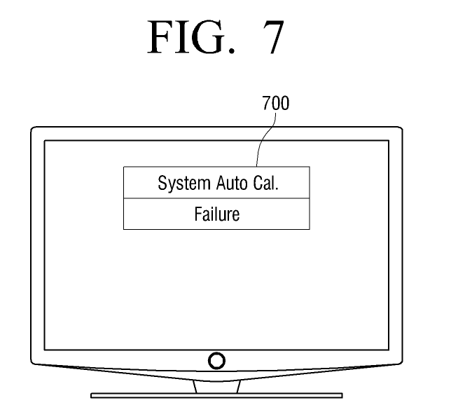

Alternatively, if the automatic calibration has performed abnormally, the display unit 145 may display on the screen a calibration failure message, as shown in FIG. 7.

The storage unit 150 stores various setting values and multimedia contents. The storage unit 150 may be implemented as a non-volatile storage medium, for example, a flash memory, a hard disk, and a CD read-only memory (ROM).

The user manipulation unit 170 receives a user manipulated command and transmits the received user manipulated command to the controller 160. For example, the user manipulation unit 170 may receive a command to select an automatic calibration item from the user. The user manipulation unit 170 may be at least one of a button, a touch screen and a remote control.

The DDR memory 180 provides volatile storage space which is to be used by the controller 160. The DDR memory 180 refers to a memory employing a data sampling scheme in a DDR mode. The DDR mode enables data to be input or output at both a rising edge and a falling edge of an external clock signal.

The controller 160 recognizes user commands based on information regarding the user manipulation transferred from the user manipulation unit 170, and controls the entire operation of the display apparatus 100 in response to the user commands.

The controller 160 uses the DDR memory 180 as volatile storage space. Additionally, the controller 160 controls the display unit 145 to display the automatic calibration item through which a command to automatically set register setting values of the DDR memory 180 is input. In more detail, when the automatic calibration item is displayed on the screen, a user may select the displayed automatic calibration item so as to command the display apparatus 100 to perform automatic calibration. Accordingly, it is possible for the user to enable calibration suitable for the display apparatus 100 to be performed in an environment where the display apparatus 100 is used.

Furthermore, the controller 160 determines whether an automatic calibration command is input. For example, if a user enters a command to select the automatic calibration item using the user manipulation unit 170, the controller 160 may determine that the automatic calibration command is input.

After the controller 160 determines that the automatic calibration command is input, register setting values of the DDR memory 180 may automatically be set so that the automatic calibration may be performed.

Herein, the register setting values of the DDR memory 180 refer to setting values to be used when data is read or recorded. The register setting values include a timing shift value of a data strobe (DQS) signal. The timing shift value of the DQS signal refers to a value for setting a shift amount of the DQS signal.

The controller 160 computes a margin of the DQS signal, and sets the timing shift value of the DQS signal using the computed margin.

In more detail, the controller 160 may read data from the DDR memory 180 or may record data on the DDR memory 180 while shifting DQS signals in sequence, and may then compute a shift range of a DQS signal in which data is normally read or recorded, as a margin. Then, the controller 160 may set a median value of the computed margin to be a timing shift value of a DQS signal.

Additionally, the controller 160 controls the display unit 145 to display information on whether the automatic calibration has performed normally, on the screen. For example, if it is determined that the automatic calibration has performed normally, the display unit 145 may display on the screen the calibration success message, as shown in FIG. 6. Alternatively, if it is determined that the automatic calibration has performed abnormally, the display unit 145 may display on the screen the calibration failure message, as shown in FIG. 7.

As described above, the display apparatus 100 may provide a user with the OSD menu and may display the automatic calibration item on the screen, so that the user may manually initiate the automatic calibration by selecting the automatic calibration item. Additionally, the display apparatus 100 may be automatically calibrated, thereby enabling the user to easily perform the automatic calibration.

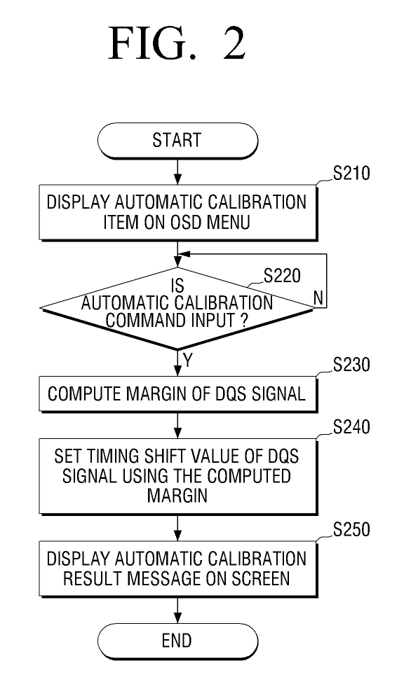

Hereinafter, a memory calibration method will be described in detail with reference to FIG. 2. FIG. 2 is a flowchart explaining the memory calibration method according to an exemplary embodiment.

In FIG. 2, the display apparatus 100 displays the automatic calibration item on the OSD menu (S210). Herein, the automatic calibration item may be utilized to input the command to automatically set register setting values. When the automatic calibration item appears on the screen as described above, a user may select the automatic calibration item to input a command for the display apparatus 100 to perform automatic calibration. Therefore, it is possible for the user to enable calibration suitable for the display apparatus 100 to be performed in the environment where the display apparatus 100 is used.

Subsequently, the display apparatus 100 determines whether the automatic calibration command is input (S220). For example, if a user enters a command to select the automatic calibration item using the user manipulation unit 170, the display apparatus 100 may determine that the automatic calibration command is input.

If it is determined that the automatic calibration command is input (S220-Y), the display apparatus 100 computes a margin of the DQS signal (S230). Additionally, the display apparatus 100 sets the timing shift value of the DQS signal using the computed margin (S240). In other words, these register setting values include the timing shift value of the DQS signal. Herein, the register setting values of the DDR memory 180 refer to setting values to be used when data is read or recorded, and the timing shift value of the DQS signal refers to a value for setting a shift amount of the DQS signal.

In more detail, the display apparatus 100 may read data from the DDR memory 180 or may record data on the DDR memory 180 while shifting DQS signals in sequence, and may then compute a shift range of a DQS signal in which data is normally read or recorded, as a margin. Then, the display apparatus 100 may set a median value of the computed margin to be a timing shift value of a DQS signal.

Subsequently, the display apparatus 100 displays an automatic calibration result message on the screen (S250). In other words, information indicating whether the automatic calibration has performed normally is displayed on the screen.

For example, if it is determined that the automatic calibration has performed normally, the display apparatus 100 may display on the screen the calibration success message, as shown in FIG. 6. Alternatively, if it is determined that the automatic calibration has performed abnormally, the display apparatus 100 may display on the screen the calibration failure message, as shown in FIG. 7.

As described above, the display apparatus 100 may provide a user with the OSD menu and may display the automatic calibration item on the screen, so that the user may manually initiate the automatic calibration by selecting the automatic calibration item. Additionally, the display apparatus 100 may be automatically calibrated, thereby enabling the user to easily perform the automatic calibration.

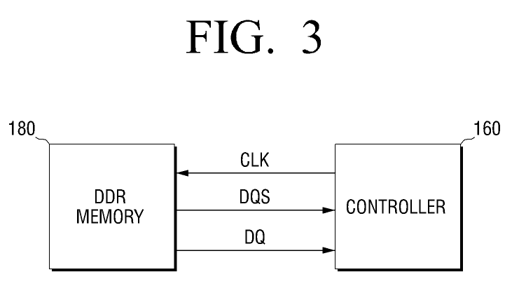

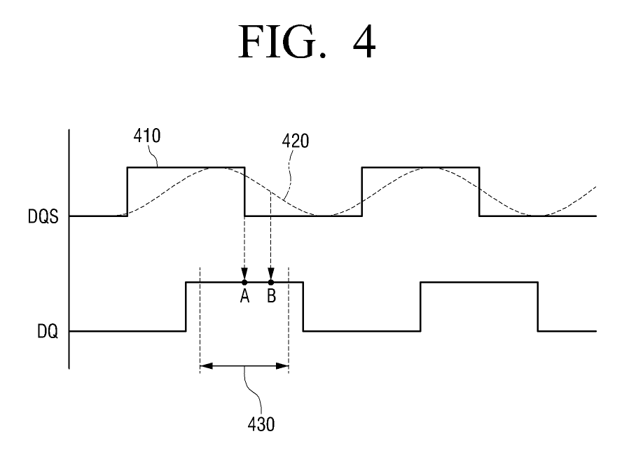

Hereinafter, signals which are transceived between the DDR memory 180 and the controller 160 will be described in detail with reference to FIGS. 3 and 4. FIG. 3 illustrates the type of signals which are transceived between the DDR memory 180 and the controller 160 according to an exemplary embodiment.

In FIG. 3, the controller 160 transmits a clock signal CLK to the DDR memory 180. The DDR memory 180 transmits to the controller 160 a DQS signal corresponding to the clock signal CLK, and a DQ signal corresponding to a data signal. Accordingly, the controller 160 may read data from the DDR memory 180 or may record data on the DDR memory 180 using these signals.

FIG. 4 exemplarily illustrates a DQS signal and a DQ signal according to an exemplary embodiment. The DDR memory 180 may read or record data of a DQ signal at a rising edge and falling edge of the DQS signal.

A first DQS signal 410 represents a fast DQS signal, and a second DQS signal 420 represents a slow DQS signal distorted due to scattering. In the case of the first DQS signal 410, the DDR memory 180 may read or record a DQ signal at point A. In the case of the second DQS signal 420, the DDR memory 180 may read or record a DQ signal at point B. The first DQS signal 410 may also be distorted due to environmental factors such as temperature or scattering of chips. Accordingly, the controller 160 may correct distortion of DQS signals through the calibration process.

During the calibration process, the controller 160 determines whether sample data has been read or recorded normally while shifting DQS signals from left to right in sequence. Additionally, the controller 160 sets an area of the DQS signal in which sample data is determined to have been read or recorded normally, to be a margin 430. Furthermore, the controller 160 sets a median value of the margin 430 to be a timing shift value of the DQS signal.

Therefore, the controller 160 may automatically calibrate the timing shift value of the DQS signal.

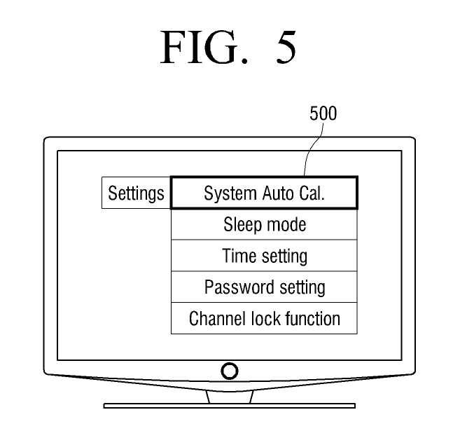

Hereinafter, an OSD menu and messages associated with the automatic calibration will be described with reference to FIGS. 5 to 7. FIG. 5 exemplarily illustrates a screen showing an OSD menu which contains an automatic calibration item 500 according to an exemplary embodiment.

As shown in FIG. 5, the display apparatus 100 may display the automatic calibration item 500 on the OSD menu. Accordingly, it is possible for a user to enter the automatic calibration command through the OSD menu.

FIG. 6 exemplarily illustrates a message 600 displayed when setting of automatic calibration has completed normally according to an exemplary embodiment. In FIG. 6, when the automatic calibration of the display apparatus 100 has performed normally, a calibration success message 600 may appear on the screen.

FIG. 7 exemplarily illustrates a message displayed when setting of automatic calibration has not completed normally according to an exemplary embodiment. In FIG. 7, when the automatic calibration of the display apparatus 100 has performed abnormally, a calibration failure message 700 may appear on the screen.

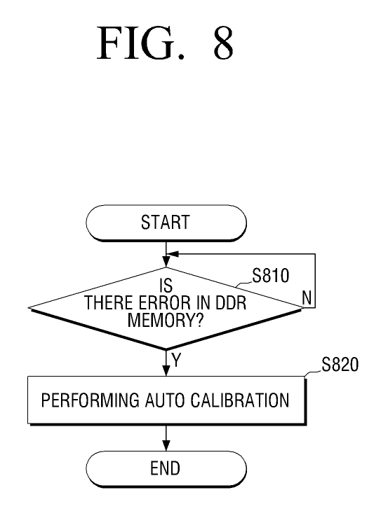

While the auto calibration is performed by a command from a user in the exemplary embodiment, the auto calibration may be performed without an extra command. This will be described below with reference to FIG. 8.

The display apparatus 100 determines whether there is an error in the DDR memory 180 or not at a predetermined time or at predetermined time intervals (S810). For example, the display apparatus 100 may determine whether there is an error in the DDR memory 180 at the time when the display apparatus 100 is turned on. Also, the display apparatus 100 may determine whether there is an error in the DDR memory 180 every one hour. The error of the memory 180 indicates that the DDR memory 180 does not normally operate, and may be an error which is caused by a user environment, a change in the program, and chip distribution.

If it is determined that there is an error in the DDR memory 180, the display apparatus 100 performs auto calibration as in operations S230 to S250 of FIG. 2.

As described above, the display apparatus 100 may determine whether there is an error in the DDR memory 180, and if so, may perform auto calibration.

While the display apparatus 100 has been described in the exemplary embodiment, there is no limitation thereto. Accordingly, the exemplary embodiments are also applicable to any device capable of displaying the automatic calibration item on the OSD menu, for example a television (TV), a monitor, a portable multimedia player (PMP) and a mobile phone.

As described above, according to an exemplary embodiment, there is provided a memory calibration method, in which an automatic calibration item through which a command may be input to automatically set register setting values of a memory is displayed, and the register setting values of the memory are automatically set upon determining that an automatic calibration command is input.

Further, according to an exemplary embodiment, there is provided a display apparatus applying the memory calibration method. Therefore, it is possible for a user to enable calibration suitable for a display apparatus to be performed in an environment where the display apparatus is used. Additionally, it is possible for the user to perform calibration of the display apparatus and stabilize the display apparatus, even when a system failure occurs due to a change in a user's environment or program used by the user and scattering of chips in a system.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A memory calibration method of a display apparatus comprising a memory, the memory calibration method comprising:
displaying an automatic calibration item on a screen of the display apparatus;
determining whether an automatic calibration command is input through manipulation of the automatic calibration item; and
automatically setting register setting values of the memory if it is determined that the automatic calibration command is input.

2. The memory calibration method as claimed in claim 1, wherein the register setting values of the memory comprise a timing shift value of a data strobe (DQS) signal, and
wherein the automatically setting the register setting values of the memory comprises:
computing a margin of the DQS signal; and
setting the timing shift value of the DQS signal based on the computed margin.

3. The memory calibration method as claimed in claim 2, wherein the computing the margin of the DQS signal comprises:
reading and recording data while shifting the DQS signal in sequence; and
computing a shift range of the DQS signal in which the data is read and recorded normally, as the margin.

4. The memory calibration method as claimed in claim 2, wherein the setting the timing shift value of the DQS signal comprises setting a median value of the margin as the timing shift value of the DQS signal.

5. The memory calibration method as claimed in claim 1, wherein the memory comprises a data sampling scheme memory employing a data sampling scheme in a double data rate mode.

6. The memory calibration method as claimed in claim 1, wherein the displaying the automatic calibration item comprises displaying the automatic calibration item on an on-screen-display menu.

7. The memory calibration method as claimed in claim 1, further comprising displaying on a screen information on whether an automatic calibration performed normally.

8. A display apparatus comprising:
a memory;
a display unit which displays an input video; and
a controller which uses the memory as a volatile storage space, controls the display unit to display an automatic calibration item, determines whether an automatic calibration command is input through manipulation of the automatic calibration item, and automatically sets the register setting values of the memory if it is determined that the automatic calibration command is input.

9. The display apparatus as claimed in claim 8, wherein the register setting values of the memory comprise a timing shift value of a data strobe (DQS) signal, and
wherein the controller computes a margin of the DQS signal, and sets the timing shift value of the DQS signal using the computed margin.

10. The display apparatus as claimed in claim 9, wherein the controller reads and records data while shifting the DQS signal in sequence, and computes a shift range of the DQS signal in which the data is read and recorded normally, as the margin.

11. The display apparatus as claimed in claim 9, wherein the controller sets a median value of the margin as the timing shift value of the DQS signal.

12. The display apparatus as claimed in claim 8, wherein the memory comprises a data sampling scheme memory employing a data sampling scheme in a double data rate mode.

13. The display apparatus as claimed in claim 8, wherein the controller controls the automatic calibration item to be displayed on an on-screen-display menu.

14. The display apparatus as claimed in claim 8, wherein the controller controls information on whether an automatic calibration performed normally to be displayed on a screen.

15. A method of calibrating a memory of a display apparatus in a user environment, the method comprising:
generating an automatic calibration item which calibrates the memory of the display apparatus if the display apparatus is in the user environment;
displaying the automatic calibration item on a screen of the display apparatus; and
setting register values of the memory of the display when the automatic calibration item is selected.

16. The method according to claim 15, further comprising:
displaying a success message if setting register values of the memory of the display performed normally.

17. The method according to claim 15, further comprising:
displaying a failure message if setting register values of the memory of the display performed abnormally.
